(19) United States
(12) Patent Application Publication
(10) Pub. No.: US 2006/0213109 A1
(43) Pub. Date: Sep. 28, 2006

(54) Fishing rod and hunting long gun holder walking stick with beverage holder

(76) Inventor: Jeffery Allen Zunker, Schertz, TX (US)

Correspondence Address: Jeffery A. Zunker, 3812 Broughton, Schertz, TX, 78154, US

(21) Appl. No.: 11/386,139

(22) Filed: Mar. 22, 2006

Related U.S. Application Data
(60) Provisional application No. 60/664,614, filed on Mar. 23, 2005.

(51) Int. Cl. A01K 97/10

(52) U.S. Cl. 43/21.2

(57) ABSTRACT

A combination walking stick and support apparatus for outdoor sport fishing, hunting, and camping is disclosed. The multiple function device includes a ground engaging, rigid support that; when engaged with the ground along with the stabilizing footing, safely holds a fishing rod or a hunting long gun in a generally upright position and at the ready for the outdoor enthusiast An integral beverage holder is fixed to the device and effectively works to secure beverages off of the ground in all applications. The formed handle support tip works effectively as a camp utility hook. The design balance and materials integration allows for a light weight, portable and efficient walking stick tool that works in multiple scenarios and significantly enhances the outdoors enthusiast experience.

This application claims the benefit of U.S. Provisional Application No. 60/664,614, filed Mar. 23, 2005.

### BACKGROUND OF THE INVENTION

1. Field of the Invention

The present invention relates to support and rack devices that are configured to engage the ground during outdoor sport fishing and hunting activities and securely hold outdoor equipment such as fishing rods and long guns, and more particularly, is directed to multiple function support and rack devices of the foregoing type, in which the device can be used as a walking or hiking stick.

2. Description of the Prior Art

The popularity of sport fishing and hunting is established as outdoor activities. Numerous supports and racks have been designed to aid outdoor enthusiast while engaging in these activities and traversing or hiking in conjunction with the activity. Since these outdoor activities require multiple devices to perform, instrumental to a successful design is a device that will complement other sport fishing and hunting equipment and not make the activity more cumbersome or difficult. No prior art combines the structure, design and materials of the Fishing Rod and Hunting Long Gun Holder Walking Stick with Beverage Holder.

U.S. Pat. No. 3,952,878 to Jack R. Gorham discloses a portable, light-weight, earth engageable gun rack adapted, when in use, to safely, effectively and dependably support a brace of two rifles or shot guns in ready to engage and use position and which, when not in use, can be collapsed and folded into a small, neat, convenient to carry package-like unit. This device works effectively as a gun holder; however, it does not perform additional functions such as a walking stick, fishing rod holder, beverage holder, or utility hook as does the Fishing Rod and Hunting Long Gun Holder Walking Stick with Beverage Holder.

U.S. Pat No. 4,144,971 to Gabriel K. Balibrea discloses a portable, lightweight, earth engageable gun stand characterized by a rigid support shaft supported by a base member from which base member depend a plurality of stake members and strengthening bracing or webbing. Again, this device works effectively as a gun holder; however, its structure does not perform the additional functions of a walking stick, fishing rod holder, beverage holder, or utility hook as does the Fishing Rod and Hunting Long Gun Holder Walking Stick with Beverage Holder.

U.S. Pat No. 4,481,964 to William J. Minneman discloses a combination walking stick and shooting rest comprises a generally L-shaped body having an elongated first member and a second member extending generally perpendicular to the first member at one end. This device acceptably works as a walking stick, however, it does not engage the ground as effective as nor perform the additional functions of a long gun holder, fishing rod holder, beverage holder or utility hook as does the Fishing Rod and Hunting Long Gun Holder Walking Stick with Beverage Holder.

U.S. Pat. No. Des. 394,300 to Francis D. Samuels, Raymond B. Samuels and Ralph L Fisher discloses an ornamental design for a combination fishing rod holder, utilitarian hook and beverage holder. This device also works acceptably within the context of sport fishing as a rod holder and drink holder, however, the design does not at all work as a hiking stick or a long gun holder as does the Fishing Rod and Hunting Long Gun Holder Walking Stick with Beverage Holder.

U.S. Pat. No. Des. 491,624 to Alfred F. Contrarino, Jr. discloses an ornamental design for a fishing rod holder with integral beverage holder. This device also works acceptably within the context of sport fishing as a rod holder and drink holder, however, the design does not at all work as hiking stick or a long gun holder as does the Fishing Rod and Hunting Long Gun Holder Walking Stick with Beverage Holder.

U.S. Pat. No. 6,035,572 to Lloyd O. Goode, Jr. discloses a combination gun rest, pivoting hunting stool, and wading stick device particularly for use by duck hunting enthusiasts. This device works effectively as a gun rest and due to its cumbersome nature, marginally as a walking stick. However, the structure of the device does not perform the additional functions of a drink holder and fishing rod holder as does the Fishing Rod and Hunting Long Gun Holder Walking Stick with Beverage Holder.

U.S. Pat. No. 6,898,891 B1 to Michael A. Needham discloses a multi-purpose tool for use in outdoor activities and, in particular, ice fishing and shore fishing. This device works effectively as a walking stick and fishing accessory tool. However, the structure of the device does not function as a long gun holder or drink holder as does the Fishing Rod and Hunting Long Gun Holder Walking Stick with Beverage Holder.

The need for a device that quite effectively performs the multiple functions of a long gun holder, fishing rod holder, drink holder, and utility hook while concurrently assisting the outdoor enthusiast as a lightweight, portable, highly durable walking stick while hiking to and from outdoor sports locations currently exists. The structure of the Fishing Rod and Hunting Long Gun Holder Walking Stick with Beverage Holder uniquely fills the above need unlike any other prior art.

### SUMMARY OF THE INVENTION

The present invention has been developed to provide a durable and extremely efficient walking stick device that has multiple purposes in sport fishing from land and hunting (especially wing shooting) from a seated or standing position. Due to the nature of its structure and materials integration, this very versatile device solves numerous efficiency and safety matters for the outdoor enthusiast. The walking stick can be used as a cane type device to steady the outdoor person walking to and returning from a fishing or hunting location (much in the same way a hiker or cross country skier uses a stick or pole device). Most importantly, upon reaching a suitable hunting or fishing location the invention serves multiple purposes to make the outdoor experience more comfortable, and in the case of hunting—safer.

In view of the above, it is an object of the invention to provide a combination walking stick, gun rest, fishing rod holder, beverage holder, and utility hook in a single device that in a non-cumbersome manner improves the efficiency and safety of the outdoor enthusiast experience.

Another objective of the present invention is to provide an apparatus that is lightweight and complements the other equipment already in use by the outdoorsman.

Another objective of the present invention is to provide an apparatus that maintains fishing and hunting equipment within convenient reach of the outdoor enthusiast.

Another objective of the present invention is to provide an apparatus that is ergonomically easy to use while walking and extremely easy to set-up once at the fishing or hunting destination.

Another objective of the present invention is to provide an apparatus that can not only be used to balance the outdoorsman while traversing outdoor terrain, but also pull them across or over obstacles.

Another objective of the present invention is to provide an apparatus that quickly can be manipulated from a walking stick to shooting stick.

Another objective of the present invention is to provide an apparatus that uses materials allowing it to be very simple in design and construction while being light weight and extremely durable to withstand extensive outdoor use and exposure to the elements.

Another objective of the present invention is to provide an apparatus with a unique design and using materials allowing safe crossing of typical waist high farm and ranch livestock electric fences.

Another objective of the present invention is to provide an apparatus that requires no mechanical take down and stores conveniently with little weight considerations.

Other objects of the present invention will in part be obvious and will in part appear hereinafter. The invention accordingly comprises the apparatuses and systems, together with their parts, elements, and interrelationships that are exemplified in the following disclosure, the scope of which will be indicated in the appended claims.

### BRIEF DESCRIPTION OF THE DRAWINGS

A more full understanding of the nature and objects of the present invention will become apparent upon consideration of the following detailed description, taken in connection with the accompanying six (6) drawings, wherein:

FIG. 1 is a side view of a support device, embodying the invention in an upright position;

FIG. 2 is a top perspective of device specifically showing the handle assembly 4; and,

FIG. 3 is a quartering topside perspective of the spring steel beverage holder 3; and,

FIG. 4 is a front view of the invention showing the entire assembly; and,

FIG. 5 is a front (in use) view of the device showing hunting form and function; and,

FIG. 6 is a front (in use) view of the device showing fishing form and function.

### PARTS REFERENCE NUMBERS

1. Main upright (elongated shaft)

2. Stabilizing Foot

3. Shaped Beverage Holder

3a. Shaped Beverage Holder Bottom Mounting Tip

3b. Shaped Beverage Holder Top Mounting Tip

4. Formed Handle

4a. Formed Handle Top

4b. Formed Handle Bottom

4c. Formed Handle Support Tip

### Detailed Description of the Preferred Embodiments

Referring now to the drawings, FIG. 1 is a side view of the entire assembly. Emphasis of the apparatus is to extreme efficiency of form and design with focus on: light weight, durability, functionality, and simplicity. The main upright (elongated shaft) 1 is round spring steel (or other similar functioning material described in alternative embodiments) approximately 9/32″ in diameter. The full assembly is 40″ in height and the main upright (elongated shaft) 1 width is 1″ at the formed handle 4. Main upright (elongated shaft) 1 and the formed handle 4 are a single assembly. The entire main upright (elongated shaft) 1 serves as the platform for all other functional parts to be attached. The complete assembly is plated, powder coated, or similarly finished after final assembly. Additionally, a grip surface is added to the formed handle 4 (described below).

FIG. 1 near bottom of the main upright (elongated shaft) 1 is the stabilizing foot 2. The stabilizing foot 2 constructed from the same or similar material as the main upright (elongated shaft) 1. The stabilizing foot 2 is connected to the main upright (elongated shaft) 1 by three weldments of no less than ½″ each.

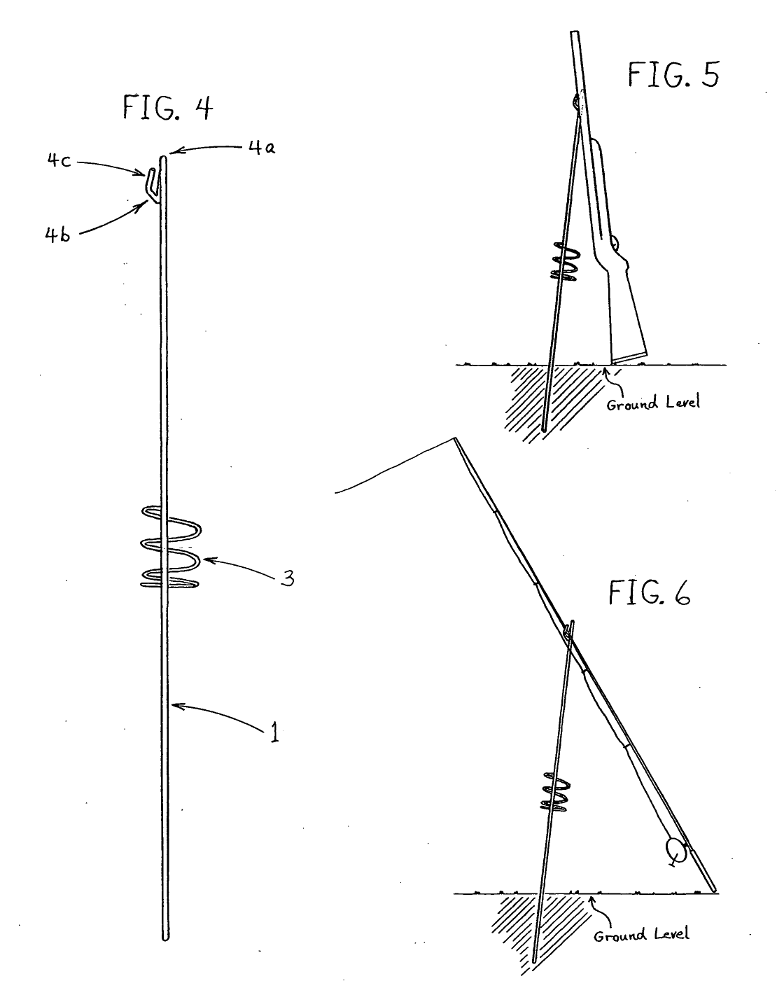

Midway up the main upright (elongated shaft) 1 is the shaped beverage holder 3. To assure maximum durability the beverage holder 3 is constructed of same or similar material as the main upright (elongated shaft) 1. This material may be of slightly smaller specifications (approximately 3/16″) than the main upright (elongated shaft) 1 since stresses are similarly less on the shaped beverage holder 3. The shaped beverage holder 3 is inline with the stabilizing foot 2 and the formed handle 4 (see FIG. 4). The structure and form of the shaped beverage holder 3 can dearly be seen in FIG. 3. Height of the beverage holder 3 is 5¼″ and the outside diameter is 3⅜″. FIG. 3 shows the shaped beverage holder 3 has two mounting tips. Shaped beverage holder bottom mounting tip 3a and shaped beverage holder top mounting tip 3b are no less than ½″ in length and act as the only two points where the shaped beverage holder 3 is connected to the main upright (elongated shaft) 1 via weldment This assembly methodology is critical for free travel and integrity of the materials of the main upright (elongated shaft) 1.

At the top of FIG. 1 is the formed handle 4. This handle is part of the same piece of material used to produce the main upright (elongated shaft) 1. The material is bent 90 degrees to form the 4⅛″ long formed handle top 4a. The shaped handle 4 is then bent 172 degrees along a curvature of 1⅞″ outside diameter to form the 4¾″ long formed handle bottom 4b. The shaped handle 4 is then bent upwards 40 degrees to form the 1¾″ long formed handle support tip.

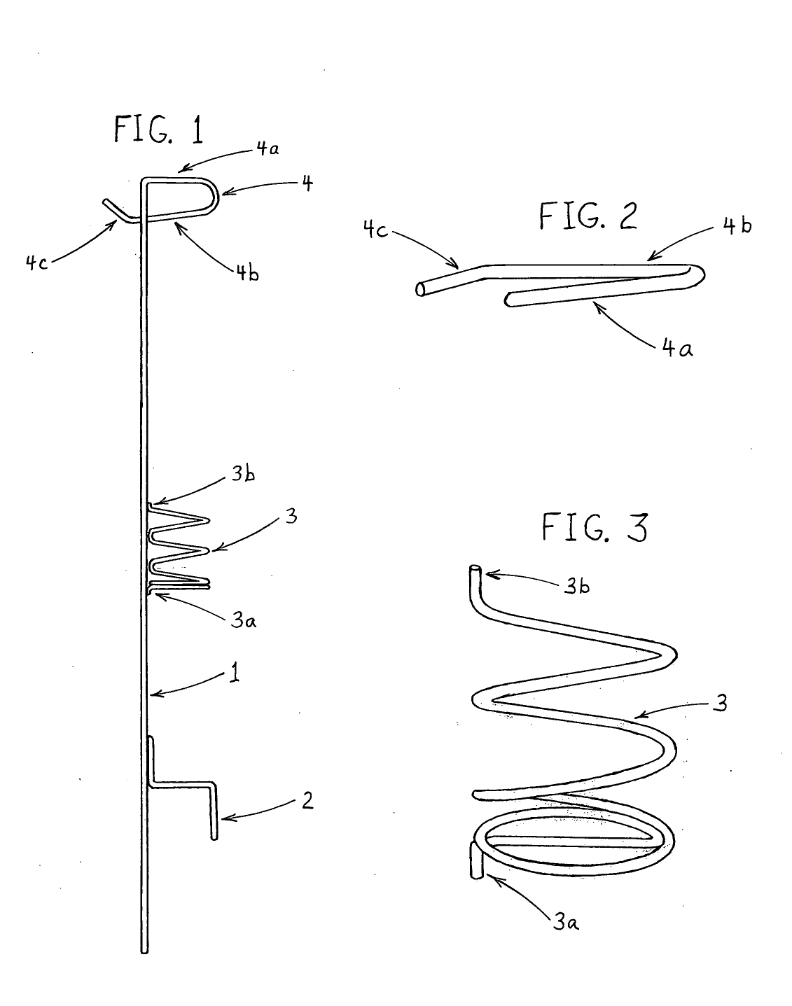

FIG. 2 is a top perspective of the Handle Assembly 4. This view dearly shows the 7-degree “roll” of the formed handle top 4a and the formed handle bottom 4b. FIG. 2 also shows the second 7-degree bend of the formed handle bottom 4b to create the 1¾″ formed handle support tip 4c.

FIG. 1 shows the formed handle 4 shaded. The shaded area pictured represents the grip material applied to the formed handle 4. Depending upon the application, this grip material should be plastic, vinyl, PVC, polyolefin (or other similar functioning material described in alternative embodiments) with excellent physical, electrical and chemical properties.

FIG. 4 is a front view of the entire assembly. This view dearly shows the orientation of the key parts of the device. Note specifically, the stabilizing foot 2, shaped beverage holder 3, and the formed handle 4 are all on the same vertical line and balance the apparatus while in use as a walking stick device.

The apparatus achieves its objectives first as being a balanced walking stick. The comfortable formed handle 4 ergonomically works with the user (just as a hiking stick) to traverse all kinds of terrain. The devices lightweight minimizes fatigue. The materials used to construct the device allow extensive use in demanding conditions. In addition, the stabilizing foot 2 can be used to “hook” onto stationary points within the terrain to “pull” the user over more difficult obstacles. Moreover, the formed handle 4 has a grip material, described above, that is to have adequate electrical shielding properties to protect the user from low amperage and/or voltage farm and ranch livestock electric fences. The entire apparatus is plated to prevent corrosion and maintain an aesthetically pleasing “look”.

Once the outdoor enthusiast uses the device as a walking stick to reach a desired location, there are multiple purposes the Fishing Rod and Hunting Long Gun Holder Walking Stick with Beverage Holder efficiently achieves. For the hunter, FIG. 5 shows the configuration with the bottom of the main upright (elongated shaft) 1 and the stabilizing foot 2 engaged into the ground. Note, the device is placed in the ground at a 5-10 degree angle in the direction the user is standing or sitting. In this manner, the apparatus naturally engages the outdoor equipment (gun or fishing rod) being used. Note in FIG. 5, the long-gun in use is safely held in an upright orientation and remains off of the ground and dean of debris. In this manner, the firearm is safely positioned for the user as well as other hunters and property in the vicinity. Also, the long gun is at the ready for the hunter to safely and quickly access when needed. While walking, the hunter may also quickly alter the device from a walking cane to a shooting rest from a kneeling, sitting, or prone position.

FIG. 6 is a front (in use) view showing fishing form and function. Engaged with the ground as described in the above paragraph, the user's fishing rod (or pole) is in position to most effectively be at the ready. In addition, with the fishing rod tip in the upright position, there is less chance of the line becoming entangled with ground obstacles. As above, the fishing equipment remains off of the ground and clean of debris.

In both cases (FIG. 5 and FIG. 6), the shaped beverage holder 3 is readily accessible to prevent spilling of beverages on uneven ground surfaces and insect invasion. Also, the formed handle support tip 4c can be used to hang accompanying outdoor equipment (i.e. hats, jackets, binoculars, etc).

### Detailed Description of the Alternative Embodiments

Spring steel referenced in preceding description may also be substituted with steel of less carbon content, stainless steel, fiberglass, composite material or any other current or future developed material that allows similar usage.

Handle grip material referenced at the top of page 3 may use numerous alternative materials or substances that achieve the intent of the original application and preferred embodiment. Alternatives may include but not be limited to:

Paint

Powder Coat

Electro-Coating

Resins (including PTFE, FEP, PFA, ETFE, ECTFE, MFA, PVDF, PEI, THV, etc.)

Polyolefin

Plastisol (VLP, HCF, etc.)

Liquid Rubber

Polyurethane

Plastic (PVC, Flexfit, Softex, VynaFoan, Vynaprene, Polysuede, Tuffoam, etc.)

Foam Material (including FHG, NPVC, UV-NPVC, Durablend, EPDM, etc.)

Plastic Foam Material (including Foam Tube, TPR, FPVC, VDM, Grip Wrap, etc.)

Plating of the entire assembly referenced on paragraph 2 of page 2 may also be substituted with paint, powder coat, electro-coating, resins, polyolefin, plastisol, liquid rubber, polyurethane, plastic, or simply by rust inhibitor.

Weldment of parts may be substituted with:

One-piece construction of similar form.

Glue, epoxy, or similar adhesive to secure parts.

Tab, screw, or bolt pieces together.

Press pieces together.

Stabilizing foot 2 may be removed entirely from the assembly for certain uses without altering the scope of the invention herein involved.

Formed handle 4 (as described in paragraph 26) may be turned upwards 90 degrees for a vertical handle parallel to the line of the elongated shaft. This difference in assembly is simply done with existing materials and structure specifications and does not alter the scope of the invention herein involved.

A utility strap may be added to the device to secure accompanying outdoor equipment together during vehicular transport or while hiking to an outdoor location. The addition of said strap does not alter the scope of the invention herein involved.

Since certain changes may be made in the foregoing disclosure without departing from the scope of the invention herein involved, it is intended that all matter contained in the above description and depicted in the accompanying drawings be construed in an illustrative and not in a limiting sense.

What is claimed is:

1. A combination hunting long-gun support, fishing rod support, lightweight walking stick, and beverage holder support apparatus comprising:
a. an elongated, ground engaging shaft,
b. a formed handle top end, further comprising;
i. a formed handle support tip,
c. a stabilizing footing, and
d. a shaped beverage holder.

2. The support apparatus described in claim 1, wherein the handle end, stabilizing footing and the beverage holder are rigidly affixed to the elongated shaft.

3. The support apparatus described in claim 1, wherein the handle end, stabilizing footing and the beverage holder are in-line vertically along said shaft.

4. The support apparatus described in claim 1, wherein the elongated shaft, handle end, stabilizing footing and beverage holder are made of spring steel, carbon, fiberglass or materials of similar properties; plated, finished or similarly weatherproofed or not; and, between 0.125 inches and 0.500 inches in diameter.

5. The support apparatus described in claim 1, wherein the shaped beverage holder is rigidly attached to the shaft at approximately the mid-point; and is attached at about two (2) points—or mounting tips—at top and bottom of the beverage holder.

6. The support apparatus described in claim 1, wherein the handle end is rigidly affixed or formed directly from the elongated shaft by bending the elongated shaft first 90 degrees and then back 180 degrees to form the handle that will accommodate comfortably and naturally the palm of one's hand; further comprising the formed handle support tip which is developed as an extension from the formed handle bottom protruding at a 45 degree upward orientation and with a seven (7) degree roll towards the centerline of the elongated shaft.

7. The support apparatus described in claim 6, wherein said formed handle end is covered with a durable grip material with electrical shielding properties.

8. The support apparatus described in claim 1, wherein the stabilizing footing is in the shape of an ell first protruding perpendicular from the bottom quartile of the elongated shaft and then downward 90 degrees and is adapted to provide purchase to the users foot to set the downward extension into the ground.
